(19) United States
(12) Patent Application Publication
(10) Pub. No.: US 2026/0238271 A1
(43) Pub. Date: Aug. 13, 2026

(54) METHOD AND NETWORK NODE IN WIRELESS COMMUNICATION SYSTEM

(71) Applicant: Samsung Electronics Co., Ltd., Suwon-si (KR)

(72) Inventors: Jian YANG, Beijing (CN); Danye WU, Beijing (CN); Hong WANG, Beijing (CN); Hyoseung KANG, Suwon-si (KR); Jeayun KO, Suwon-si (KR)

(21) Appl. No.: 19/531,025

(22) Filed: Feb. 5, 2026

Related U.S. Application Data
(63) Continuation of application No. PCT/KR2026/002054, filed on Feb. 4, 2026.

(30) Foreign Application Priority Data
Feb. 8, 2025 (CN) 202510142394.2
Jul. 31, 2025 (CN) 202511075721.3

(51) Int. Cl. H04B 7/06

(52) U.S. Cl. CPC H04B 7/0617; H04B 7/06966

(57) ABSTRACT

A method and a network node in a wireless communication system are provided. The method includes receiving, from a second network node, first information related to the second network node supporting sounding reference signal based beamforming (SRS-BF) and transmitting, to the second network node, a configuration message for demodulation reference signal based beamforming (DMRS-BF), wherein the configuration message includes first user equipment (UE)-related configuration information corresponding to the DMRS-BF and second UE-related configuration information corresponding to the SRS-BF.

### CROSS-REFERENCE TO RELATED APPLICATION(S)

This application is a continuation application, claiming priority under 35 U.S.C. § 365 (c), of an International application No. PCT/KR2026/002054, filed on Feb. 4, 2026, which is based on and claims the benefit of a Chinese patent application number 202510142394.2, filed on Feb. 8, 2025, in the Chinese Intellectual Property Office, and of a Chinese patent application number 202511075721.3, filed on Jul. 31, 2025, in the Chinese Intellectual Property Office, the disclosure of each of which is incorporated by reference herein in its entirety.

### TECHNICAL FIELD

The disclosure relates to the field of wireless communication technology. More particularly, the disclosure relates to a method and a network node in a wireless communication system.

### BACKGROUND

In order to meet an increasing demand for wireless data communication services since a deployment of 4^{th} generation (4G) communication system, efforts have been made to develop an improved 5^{th} generation (5G) or pre-5G communication system. Therefore, the 5G or pre-5G communication system is also called “beyond 4G network” or “post long-term evolution (LTE) system.”

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

5^{th}-Generation (5G), mobile communication technology, has been gradually standardized, and its three application scenarios mainly include ultra-reliable and low latency communication (URLLC), enhanced mobile broadband (EMBB) and massive machine type communication (mMTC). However, with the application and development of 5G, more and more devices and mobile data are connected to the 5G system, and the radio access network (RAN) is facing the problems of increasing business volume, huge investment cost and insufficient flexibility. In order to solve these problems, operators hope to achieve faster innovation and higher flexibility, reduce equipment costs and achieve higher performance by opening up the standardization of third-party equipment.

In this situation, open radio access network (O-RAN) standard came into being. O-RAN allows network devices from different suppliers to interoperate, and the standardized interface becomes more open and the functions are more flexible. At the same time, the introduction of machine learning and artificial intelligence will bring new opportunities to O-RAN and accelerate the innovation speed. An open and intelligent wireless access network is conducive to reducing equipment costs, stimulating innovation, and promoting the application of various new fields to the market faster.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide to a method and a network node in a wireless communication system.

Additional aspects will be set forth in part in the description which follows and, in part, will be apparent from the description, or may be learned by practice of the presented embodiments.

In accordance with an aspect of the disclosure, a method performed by a first network node in a wireless communication system is provided. The method includes receiving, from a second network node, first information related to the second network node supporting sounding reference signal based beamforming (SRS-BF) and transmitting, to the second network node, a configuration message for demodulation reference signal based beamforming (DMRS-BF), wherein the configuration message includes first user equipment (UE)-related configuration information corresponding to the DMRS-BF and second UE-related configuration information corresponding to the SRS-BF.

In an implementation, the transmitting, to the second network node, the configuration message for the DMRS-BF includes transmitting, to the second network node, the configuration message for the DMRS-BF when the SRS-BF can be applied to the DMRS-BF, where the configuration message includes the first UE-related configuration information and the second UE-related configuration information.

In an implementation, the first UE-related configuration information is carried in a first section extension of the configuration message, and the second UE-related configuration information is carried in a second section extension corresponding to the first section extension in the configuration message.

In an implementation, the first section extension includes at least one first extension field, the second section extension includes at least one second extension field, and a first extension field of the at least one first extension field that includes the first UE-related configuration information corresponds to a second extension field of the at least one second extension field that includes the second UE-related configuration information.

In an implementation, the first information includes identification information of the second section extension.

In an implementation, the second section extension includes at least one of UE index related information and antenna port related information.

In an implementation, the antenna port related information includes at least one of at least one antenna port index, a number of antenna ports, and an index of an antenna port with a largest index value.

In an implementation, the DMRS-BF and the SRS-BF correspond to a same UE, and the second UE-related configuration information includes indication information indicating that the DMRS-BF and the SRS-BF correspond to the same UE.

In an implementation, the receiving, from the second network node, the first information related to the second network node supporting the SRS-BF includes receiving, from the second network node, a management plane message, where the management plane message includes the first information related to the second network node supporting the SRS-BF.

In an implementation, the transmitting, to the second network node, the configuration message for the DMRS-BF includes transmitting, to the second network node, a control plane message, where the control plane message includes the configuration message for the DMRS-BF.

In an implementation, the transmitting, to the second network node, the configuration message for the DMRS-BF includes transmitting, to the second network node, the configuration message for the DMRS-BF when scheduling and processing of a physical uplink shared channel (PUSCH) belong to a same SRS channel information reporting period.

In an implementation, the method further includes transmitting, to the second network node, SRS configuration information, where the SRS configuration information includes at least one of an SRS configuration period, UE priority information, and receiving, from the second network node, channel information, where the channel information is determined by the second network node based on the SRS configuration information.

In accordance with an aspect of the disclosure, a method performed by a second network node in a wireless communication system is provided. The method includes transmitting, to a first network node, first information related to the second network node supporting sounding reference signal based beamforming (SRS-BF) and receiving, from the first network node, a configuration message for demodulation reference signal based beamforming (DMRS-BF), wherein the configuration message includes first UE-related configuration information corresponding to the DMRS-BF and second UE-related configuration information corresponding to the SRS-BF.

In an implementation, the receiving, from the first network node, the configuration message for the DMRS-BF includes receiving, from the first network node, the configuration message for the DMRS-BF when the SRS-BF can be applied to the DMRS-BF, where the configuration message includes the first UE-related configuration information and the second UE-related configuration information.

In an implementation, the first UE-related configuration information is carried in a first section extension of the configuration message, and the second UE-related configuration information is carried in a second section extension corresponding to the first section extension in the configuration message.

In an implementation, the first section extension includes at least one first extension field, the second section extension includes at least one second extension field, and a first extension field of the at least one first extension field that includes the first UE-related configuration information corresponds to a second extension field of the at least one second extension field that includes the second UE-related configuration information.

In an implementation, the first information includes identification information of the second section extension.

In an implementation, the second section extension includes at least one of UE index related information and antenna port related information.

In an implementation, the antenna port related information includes at least one of at least one antenna port index, a number of antenna ports, and an index of an antenna port with a largest index value.

In an implementation, the DMRS-BF and the SRS-BF correspond to a same UE, and the second UE-related configuration information includes indication information indicating that the DMRS-BF and the SRS-BF correspond to the same UE.

In an implementation, the transmitting, to the first network node, the first information related to the second network node supporting the SRS-BF includes transmitting, to the first network node, a management plane message, where the management plane message includes the first information related to the second network node supporting the SRS-BF.

In an implementation, the receiving, from the first network node, the configuration message for the DMRS-BF includes receiving, from the first network node, a control plane message, where the control plane message includes the configuration message for the DMRS-BF.

In an implementation, the receiving, from the first network node, the configuration message for the DMRS-BF includes receiving, from the first network node, the configuration message for the DMRS-BF when scheduling and processing of a physical uplink shared channel (PUSCH) belong to a same SRS channel information reporting period.

In an implementation, the method further includes receiving, from the first network node, SRS configuration information, where the SRS configuration information includes at least one of an SRS configuration period, UE priority information, determining channel information based on the SRS configuration information, and transmitting, to the first network node, the channel information.

In an implementation, the method further includes performing the DMRS-BF based on the configuration message for the DMRS-BF.

In accordance with an aspect of the disclosure, a method performed by a first network node in a wireless communication system is provided. The method includes determining whether sounding reference signal based beamforming (SRS-BF) is used to perform demodulation reference signal based beamforming (DMRS-BF) and transmitting, to a second network node, first information including a first user equipment identifier (UEID) for the DMRS-BF and second information including a second user equipment identifier (UEID) for the SRS-BF if the SRS-BF is used to perform the DMRS-BF, wherein the first user equipment identifier and the second user equipment identifier indicate a same user equipment (UE).

In an implementation, the method further includes receiving, from the second network node, third information related to whether the second network node supports the SRS-BF and the DMRS-BF, where the determining whether the SRS-BF is used to perform the DMRS-BF includes determining whether the SRS-BF is used to perform the DMRS-BF based on receiving the third information related to the second network node supporting the SRS-BF and the DMRS-BF from the second network node.

In an implementation, the third information includes fourth information related to a number of bits of a user index of the second user equipment identifier and fifth information related to whether transmission of a section extension of the second user equipment identifier is supported.

In an implementation, the section extension of the second user equipment identifier includes at least one of a plurality of second user equipment identifiers, where the plurality of second user equipment identifiers include a same user index and different indices of antenna ports, one user index and a plurality of different indices of antenna ports, one second user equipment identifier, where a least-significant bit of the second user equipment identifier indicates an index of any antenna port, one second user equipment identifier, where the least-significant bit of the second user equipment identifier indicates a largest index of the antenna ports, and one second user equipment identifier, where the least-significant bit of the second user equipment identifier indicates a number of the antenna ports.

In an implementation, the receiving, from the second network node, the third information related to whether the second network node supports the SRS-BF and the DMRS-BF includes receiving, from the second network node, a management plane message including a list of section extensions, where the method further includes determining whether the second network node supports the SRS-BF and the DMRS-BF based on whether the list of section extensions in the management plane message includes a section extension related to transmission of the second user equipment identifier.

In an implementation, the transmitting, to the second network node, the first information including the first user equipment identifier for the DMRS-BF and the second information including the second user equipment identifier for the SRS-BF includes transmitting, to the second network node, the first information including the first user equipment identifier for the DMRS-BF and the second information including the second user equipment identifier for the SRS-BF through a control plane message.

In an implementation, at least one user index in the section extension of the second user equipment identifier corresponds one-to-one to at least one user index in a section extension of the first user equipment identifier.

In accordance with an aspect of the disclosure, a method performed by a second network node in a wireless communication system is provided. The method includes receiving, from a first network node, first information including a first user equipment identifier for demodulation reference signal based beamforming (DMRS-BF) and second information including a second user equipment identifier for sounding reference signal based beamforming (SRS-BF), wherein the first user equipment identifier and the second user equipment identifier indicate a same user equipment (UE) and performing the DMRS-BF based on the SRS-BF according to the first user equipment identifier and the second user equipment identifier.

In an implementation, the method further includes transmitting, to the first network node, third information related to whether the second network node supports the SRS-BF and the DMRS-BF, where the third information is used to determine whether the SRS-BF is used for the DMRS-BF.

In an implementation, the third information includes fourth information related to a number of bits of a user index of the second user equipment identifier and fifth information related to whether transmission of a section extension of the second user equipment identifier is supported.

In an implementation, the section extension of the second user equipment identifier includes at least one of a plurality of second user equipment identifiers, where the plurality of second user equipment identifiers include a same user index and different indices of antenna ports, one user index and a plurality of different indices of antenna ports, one second user equipment identifier, where a least-significant bit of the second user equipment identifier indicates an index of any antenna port, one second user equipment identifier, where the least-significant bit of the second user equipment identifier indicates a largest index of the antenna ports, and one second user equipment identifier, where the least-significant bit of the second user equipment identifier indicates a number of the antenna ports.

In an implementation, the transmitting, to the first network node, the third information related to whether the second network node supports the SRS-BF and the DMRS-BF includes transmitting, to the first network node, a management plane message including a list of section extensions, where the list of section extensions is used to determine whether the second network node supports the SRS-BF and the DMRS-BF.

In an implementation, the receiving, from the first network node, the first information including the first user equipment identifier for the DMRS-BF and the second information including the second user equipment identifier for the SRS-BF includes receiving, from the first network node, the first information including the first user equipment identifier for the DMRS-BF and the second information including the second user equipment identifier for the SRS-BF through a control plane message.

In an implementation, at least one user index in the section extension of the second user equipment identifier corresponds one-to-one to at least one user index in a section extension of the first user equipment identifier.

In accordance with an aspect of the disclosure, a method performed by a first network node in a wireless communication system is provided. The method includes determining whether sounding reference signal based beamforming (SRS-BF) is used to perform demodulation reference signal based beamforming (DMRS-BF) and transmitting, to a second network node, first information including a first user equipment identifier for the DMRS-BF and first indication information if the SRS-BF is used to perform the DMRS-BF, wherein the first indication information is used to indicate the second network node to use, for the SRS-BF, a same user index as that of the first user equipment identifier.

In an implementation, the method further includes receiving, from the second network node, third information related to whether the second network node supports the SRS-BF and the DMRS-BF, where the determining whether the SRS-BF is used to perform the DMRS-BF includes determining whether the SRS-BF is used to perform the DMRS-BF based on receiving the third information from the second network node through a management plane message related to the second network node supporting the SRS-BF and the DMRS-BF.

In an implementation, the third information includes fourth information related to a number of bits of user indices of the first user equipment identifier and the second user equipment identifier.

In an implementation, the transmitting, to the second network node, the first information including the first user equipment identifier for the DMRS-BF and the first indication information includes transmitting, to the second network node, the first information including the first user equipment identifier for the DMRS-BF and the first indication information through a control plane message.

In accordance with an aspect of the disclosure, a method performed by a second network node in a wireless communication system is provided. The method includes receiving, from a first network node, first information including a first user equipment identifier for demodulation reference signal based beamforming (DMRS-BF) and first indication information, wherein the first indication information is used to indicate the second network node to use, for sounding reference signal based beamforming (SRS-BF), a same user index as that of the first user equipment identifier and performing the DMRS-BF based on the SRS-BF according to a user index for the DMRS-BF and a user index for the SRS-BF.

In an implementation, the method further includes transmitting, to the first network node, third information related to whether the second network node supports the SRS-BF and the DMRS-BF through a management plane message.

In an implementation, the third information includes the first user equipment identifier and fourth information related to a number of bits of a user index of the second user equipment identifier.

In an implementation, the receiving, from the first network node, the first information including the first user equipment identifier for the DMRS-BF and the first indication information includes receiving, from the first network node, the first information including the first user equipment identifier for the DMRS-BF and the first indication information through a control plane message.

In accordance with an aspect of the disclosure, a first network node in a wireless communication system is provided. The first network node includes memory, including one or more storage media, storing instructions, a transceiver and at least one processor communicatively coupled to the memory and the transceiver, wherein the instructions, when executed by the at least one processor individually or collectively, cause the first network node to receive, from a second network node, first information related to the second network node supporting sounding reference signal based beamforming (SRS-BF), and transmit, to the second network node, a configuration message for demodulation reference signal based beamforming (DMRS-BF), and wherein the configuration message comprises first user equipment (UE)-related configuration information corresponding to the DMRS-BF and second UE-related configuration information corresponding to the SRS-BF.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates a diagram of a reference architecture of a base station of an open radio access network (O-RAN) according to an embodiment of the disclosure;

FIG. 2A illustrates an example of a processing flow for transmitting and receiving downlink air interface data in an O-RAN according to an embodiment of the disclosure;

FIG. 2B illustrates an example of a processing flow for transmitting and receiving uplink air interface data in an O-RAN according to an embodiment of the disclosure;

FIG. 3 illustrates a schematic diagram of a structure of a control plane message transport layer according to an embodiment of the disclosure;

FIGS. 4, 5, 6, and 7 illustrate flowcharts of methods performed by a first network node according to various embodiments of the disclosure;

FIGS. 8 and 9 illustrate flowcharts of methods performed by a second network node according to various embodiments of the disclosure;

FIG. 10 illustrates a flowchart of a method for solving out-of-synchronization of channel information according to an embodiment of the disclosure; and

FIG. 11 illustrates a block diagram of a network node according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, a reference to a “component surface” includes reference to one or more of such surfaces.

The term “include” or “may include” refers to the presence of corresponding disclosed functions, operations, or components that may be used in various embodiments of the disclosure, and do not limit the presence of one or more additional functions, operations, or features. In addition, the term “include” or “have” may be interpreted as indicating certain characteristics, numbers, steps, operations, constituent elements, components, or combinations thereof, but should not be interpreted as excluding the possibility of the existence of one or more other characteristics, numbers, steps, operations, constituent elements, components, or combinations thereof.

The term “or” used in various embodiments of the disclosure includes any of the listed terms and all combinations thereof. For example, “A or B” may include A, may include B, or may include both A and B.

Unless defined differently, all terms (including technical terms or scientific terms) used in the disclosure have the same meanings as understood by those skilled in the art to which the disclosure belongs. Common terms as defined in dictionaries are interpreted as having meanings consistent with the context in the relevant technical field, and should not be interpreted ideally or overly formally unless explicitly so defined in the disclosure.

The drawings discussed below and the various embodiments used to describe the principles of the disclosure in the patent document are for illustration only and should not be interpreted as limiting the scope of the disclosure in any way. Those skilled in the art will understand that the principles of the disclosure may be implemented in any suitably arranged system or device.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

In the basic architecture of O-RAN, the fronthaul interface (FH IF) between O-RAN distributed unit (O-DU) and O-RAN radio unit (O-RU) is an open network. There must be strict requirements on transmission delay in limited bandwidth resources, and effectively reducing the load of the fronthaul interface is also the key content to be considered and optimized in O-RAN. Currently, the optimization of the O-RAN fronthaul load is mainly that the user plane uses various compression algorithms to reduce the number of bits required to transmit the same data, while the control plane reduces the number of bits of control messages transmitted through various extensions. However, existing implementations do not consider 5G periodic transmission characteristics and repeated transmission characteristics. Optimizing the fronthaul interface based on these transmission characteristics can reduce the number of transmissions of user plane messages and control plane messages, thereby further reducing the fronthaul load and improving transmission reliability and stability.

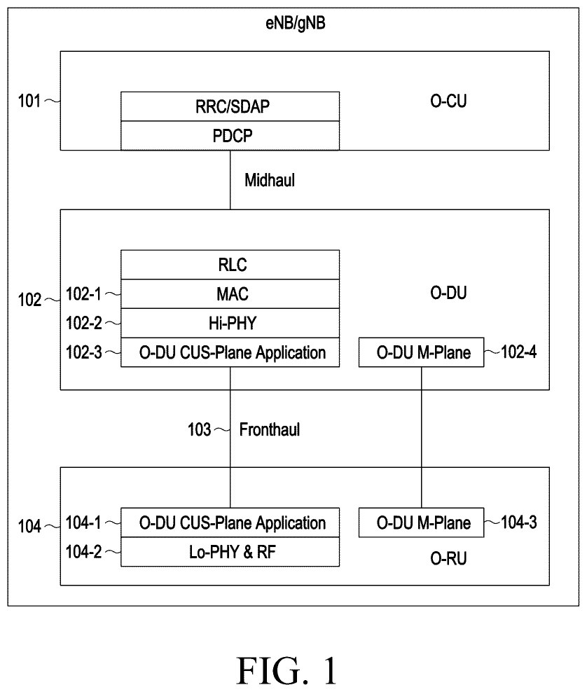

FIG. 1 illustrates a diagram of a reference architecture of a base station of an O-RAN according to an embodiment of the disclosure.

Referring to FIG. 1, it illustrates the base station reference architecture in O-RAN.

The base station in the figures can be a next generation NodeB (gNB) (new radio (NR) base station) that supports 5G NR standard, and can also be an evolved NodeB (eNB) (LTE base station) that supports 4G LTE. The reference architectures of gNB and eNB are slightly different, but they have no impact on the content of the disclosure, so gNB and eNB are not distinguished. Other functional entities outside the base station in the O-RAN and the interfaces between them and the base station are also not involved in the disclosure, and therefore are not shown in the figures. The specific modules in the O-RAN reference architecture will be introduced below, and unrelated modules will not be described further.
101 O-RAN central unit (O-CU): a logical node including O-RAN central unit-control plane (O-CU-CP) and O-RAN central unit-user plane (O-CU-UP). O-CU-CP is a logical node including radio resource control layer (RRC) and packet data convergence protocol (PDCP) layer control plane parts, and O-CU-UP is a logical node including service data adaptation protocol (SDAP) and PDCP user plane parts.
102 O-RAN distributed unit (O-DU): a logical node based on the lower layer functional split and including radio link control layer (RLC), media access control (MAC) layer, high physical (high-PHY) layer.
102-1 MAC: third generation partnership project (3GPP) function layer, which is mainly responsible for mapping of logical channels and transport channels, multiplexing MAC service data units (SDUs) from one or more different logical channels to transport blocks (TBs) for transmission to the physical layer on the transport channel, and can also implement demultiplexing of MAC SDUs from TBs transmitted by the transport channel to one or more different logical channels. Scheduling information reporting is also supported, for example, functions, such as error correction through hybrid automatic repeat request (HARQ) and data transmission according to the priorities of logical channels.
102-2 High-PHY: a function for processing at the physical layer on the O-DU side of the fronthaul interface after the physical layer of the 3GPP functional layer is split, including forward error correction coding/decoding, channel estimation, modulation/demodulation, scrambling/descrambling and other functions.
102-3 O-DU CUS-plane application (O-DU control, user, synchronization plane application, which is abbreviated as an O-DU application in the disclosure): an O-DU logical function, which is responsible for creating and transmitting or receiving and processing messages of control-plane (C-plane), user-plane (U-plane) and synchronization-plane (S-plane) to or from O-RAN radio unit (O-RU) on the fronthaul interface. The control plane specifically refers to the real-time control information between O-DU and O-RU, and the control plane message carries related information for controlling user plane messages (for example, information, such as scheduling, coordination required for data transmission, beamforming, or the like), the user plane message carries the time-frequency domain in-phase/quadrature (I/Q) data transmitted between O-DU and O-RU, and the synchronization plane message is used to realize timing and time-frequency synchronization between O-DU and O-RU. C-plane, U-plane and S-plane (CUS-plane) is transmitted in real time on the fronthaul interface between O-DU and O-RU according to data scheduling.
102-4 O-DU management plane (O-DU M-Plane): an O-DU logical function, which refers to non-real-time management operations between O-DU and O-RU, initializing O-RU, software management, configuration management, performance management, fault management, file management, or the like, based on network configuration/yet another next generation (NETCONF/YANG) (network configuration protocol/YANG data modeling language), where the configuration of management-plane (M-plane) is usually relatively static.
103 O-RAN open fronthaul interface (OFH I/F): fronthaul is a logical link connecting O-DU and O-RU, and is responsible for transmitting information of the control plane, user plane, synchronization plane and management plane. The FH IF includes a CUS-plane interface and an M-plane interface, and is an interface based on enhanced common public radio interface (eCPRI) or institute of electrical and electronics engineers (IEEE).
104 O-RAN radio unit (O-RU): is a logical node based on lower layer functional split, carrying low physical layer (Low-PHY) and radio frequency (RF) processing.
104-1 O-RU control, user, synchronization plane application (O-RU CUS-plane application), which is abbreviated as an O-RU application in the disclosure: an O-RU logical function, which is responsible for transmitting or receiving and processing messages of C-Plane, U-Plane and S-Plane to or from O-DU on the fronthaul interface.
104-2 Low-PHY: a function for processing on the O-RU side of the fronthaul interface after the physical layer of the 3GPP functional layer is split, which is responsible for fast Fourier transformation/invert fast Fourier transformation (FFT/IFFT), analog beamforming, digital beamforming, digital-to-analog/analog-to-digital conversion and other functions.
104-3 O-RU management plane (O-RU M-Plane), which is an O-RU logical function and managed by the O-DU M-Plane, and performs capability reporting to the O-DU during the initialization stage to notify the O-DU which optional capabilities the O-RU supports.

In the method for controlling the transmitting and receiving of air interface data in real time based on the control plane message, there are different processes for uplink and downlink.

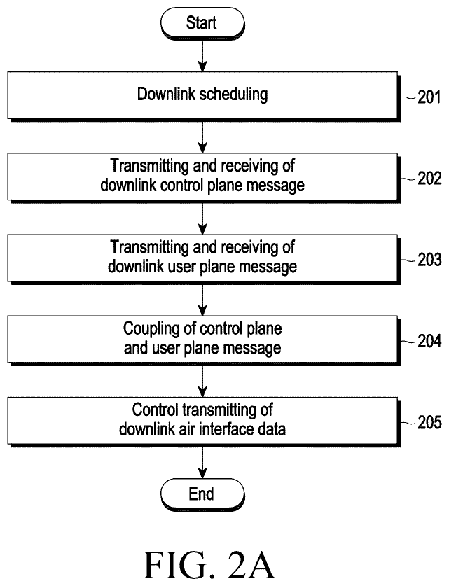

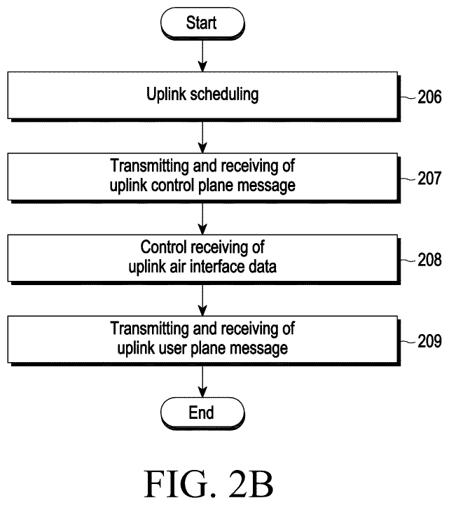

FIG. 2A illustrates a processing flow of downlink data according to an embodiment of the disclosure.

Referring to FIG. 2A, operation 201 is downlink scheduling, which is performed in the O-DU, specifically in the 102-1 MAC scheduler. After the MAC scheduler completes the downlink scheduling, it will transmit the downlink scheduling results to the High-PHY for processing, such as modulation and coding, and will also transmit the scheduling results to the 102-3 O-DU application for the creation of control plane messages and user plane messages. The minimum time domain granularity of the downlink scheduling result is an orthogonal frequency division multiplexing symbol (OFDM symbol), and the minimum frequency domain granularity is an resource element (RE) (occupying one OFDM symbol in the time domain and occupying one subcarrier in the frequency domain). The scheduling results include but are not limited to time domain and frequency domain resource allocation information, beam index, or the like, of physical downlink shared channel (PDSCH), physical downlink control channel (PDCCH), channel state information-reference signal (CSI-RS).

Operation 202 is transmitting and receiving of downlink control plane messages, which is performed in the O-DU and O-RU, specifically in the 102-3 O-DU application, 103 FH I/F, and 104-1 O-RU application. The O-DU application creates a control plane message for controlling downlink air interface data transmission based on the scheduling result in operation 201, and transmits it to the O-RU application through FH I/F. The control plane message mainly indicates OFDM symbols, physical resource block (PRB) (consisting of RE), RE, beam index, IFFT parameters and other information. The O-RU application receives the control plane message and obtains various field information of the transport layer and application layer from the control plane message.

Operation 203 is transmitting and receiving of downlink user plane messages, which is performed in the O-DU and O-RU, specifically in the 102-3 O-DU application, 103 FH I/F, and 104-1 O-RU application. The O-DU application creates the modulated and encoded I/Q data output by the High-PHY as a downlink user plane message and transmits it to the O-RU application through the FH I/F. The user plane message mainly carries the I/Q data carried on the specified OFDM symbol and each RE in the PRB. The O-RU application receives the user plane message and obtains various field information of the transport layer and application layer and the I/Q data from the user plane message.

Operation 204 is coupling of control plane/user plane messages, which is performed in the O-RU, specifically in the 104-1 O-RU application. since the control plane message and the user plane message are transmitted separately, the section description in the control plane information and the data section in the user plane message need to be coupled, and the basic coupling method is coupling based on the section index (sectionID). In addition, in order to reduce the number of section descriptions in the control plane message, coupling methods, such as coupling based on time-frequency resources and coupling based on time-frequency resources with priorities are proposed.

Operation 205 is controlling of transmission of downlink air interface data, which is performed in the O-RU, specifically in the 104-1 O-RU application and 104-2 Low-PHY. After the O-RU application completes the coupling, it delivers the coupled section description and data section to the Low-PHY, and the Low-PHY processes the coupled section description and data section, and performs processing, such as digital beamforming, fast Fourier transformation (IFFT), and analog beamforming on the downlink data section according to the control information indicated in the section description.

FIG. 2B illustrates a processing flow of uplink data according to an embodiment of the disclosure.

Referring to FIG. 2B, operation 206 is uplink scheduling, which is performed in the O-DU, specifically in the 102-1 MAC scheduler. After the MAC scheduler completes the uplink scheduling, it will transmit the uplink scheduling results to the High-PHY for processing, such as decoding and demodulation after receiving the User Plane data of the O-RU, and will also transmit the scheduling results to the O-DU application for the creation of control plane messages. The minimum time domain granularity of the uplink scheduling result is an OFDM symbol, and the minimum frequency domain granularity is an RE. The scheduling results include but are not limited to time domain and frequency domain resource allocation information, beam index, or the like, of physical uplink shared channel (PUSCH), physical uplink control channel (PUCCH), sounding reference signal (SRS), physical random access channel (PRACH), demodulation reference signal (DMRS).

Operation 207 is transmitting and receiving of uplink control plane messages, which is performed in the O-DU and O-RU, specifically in the 102-3 O-DU application, 103 FH I/F, and 104-1 O-RU application. The O-DU application creates a control plane message for controlling the reception of uplink air interface data based on the scheduling result in operation 206, and transmits it to the O-RU application through the FH I/F. The control plane message mainly indicates OFDM symbols, PRB, RE, beam index and FFT parameters and other information. The O-RU application receives the control plane message and obtains various field information of the transport layer and application layer from the control plane message.

Operation 208 is controlling of reception of uplink air interface data, which is performed in the O-RU, specifically in the 104-1 O-RU application and 104-2 Low-PHY. The O-RU application indicates the control information carried by the section description extracted from the control plane message to the Low-PHY. The Low-PHY performs processing, such as analog beamforming, FFT, digital beamforming on the uplink air interface data based on the control information, and then delivers the processed I/Q data to the O-RU application.

Operation 209 is transmitting and receiving of uplink user plane messages, which is performed in the O-RU and O-DU, specifically in the 104-1 O-RU application, 103 FH I/F, and 102-3 O-DU application. The O-RU application creates the I/Q data output from the Low-PHY as an uplink user plane message, and transmits it to the O-DU application through the FH I/F. The user plane message mainly carries the I/Q data carried on the specified OFDM symbol and each RE in the PRB. The O-DU application receives the user plane message and obtains the I/Q data carried on the specified OFDM symbol and each RE in the PRB from the user plane message, and then delivers the I/Q data to the High-PHY for subsequent processing, such as decoding and demodulation.

Each control plane message in FIGS. 2A and 2B belongs to a certain endpoint (which can be a transmitting endpoint corresponding to downlink low-level-tx-endpoint, or a receiving endpoint corresponding to uplink low-level-rx-endpoint). Each endpoint is assigned a unique extended antenna-carrier identifier or index (eAxC ID), which is carried in the transport layer header of the control plane message and the user plane message, and used for the O-RU and O-DU to distinguish which endpoint the message belongs to.

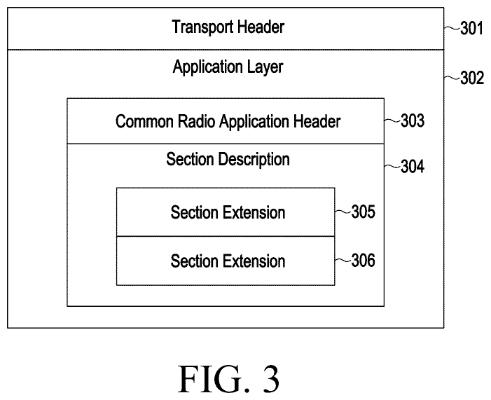

FIG. 3 illustrates a schematic diagram of a structure of a control plane message transport layer according to an embodiment of the disclosure.

Referring to FIG. 3, it illustrates eAxC ID divided into ecpriRtcID and ecpriPcID, where ecpriRtcID (real time control data identifier) is used to identify the data flow related to the control plane message, and the transport layer structure in the control plane message, in which,
301 Transport header: it may be an enhanced common public radio interface (eCPRI) header and a radio over ethernet (ROE) header, including corresponding fields for indicating the message type, for example, information, such as eAxC ID.
302 Application layer: it includes necessary fields for control and synchronization, i.e., transport layer payload.
303 Common radio application header: it includes information, such as data direction, payload version, filter index, frame number (frameID), subframe number (subframeID), slot number (slotID), start symbol index (start SymbolID), a number of sections and section type.
304 Section description: it describes control information, including information used to control the transmitting or receiving of user plane messages. A control plane message can include multiple section descriptions.
305 Section header: it includes information, such as section index (sectionID), symbol increment flag (symInc), a number of symbols (numSymbol), and frequency domain resource information (such as: section description start PRB (startPrbc), a number of consecutive PRBs in the section description (numPrbc), a number of symbols (numSymbol)), beam index (beamID), extension identifier (ef).
306 Section extension, which describes the control information in addition to the information included in the section header. A section description can include multiple section extensions. If the value of the extension identifier ef is 1, it means that there are other section extensions following this section extension.

The beamforming methods currently supported by the O-RAN include: predefined-beam beamforming (PDBF), weight-based dynamic beamforming (WDBF), attribute-based dynamic beamforming (ABBF), channel-information-based beamforming (CIBF) and DMRS-based beamforming (DMRS-BF).

In DMRS-BF, the O-DU provides a DMRS configuration description of the PUSCH, the O-RU performs channel estimation based on the received DMRS, calculates beamforming weights from the DMRS data with or without an equalization function, and applies the weights to the PUSCH data and optional DMRS data. Since no beam index is used in this method, the usage of the related beam index is not related to this beamforming method. This beamforming method is only applicable to NR PUSCH. Currently, DMRS-based beamforming has been applied to the O-RU to reduce the complexity and bandwidth occupancy of the fronthaul.

In the control plane of the O-RAN, section type 5 mainly includes user equipment scheduling information, the field user equipment identifier (UEID) included in which is a 15-bit unsigned integer field. In the environment of DMRS-BF, UEID is divided into two parts to represent the UE identifier and the layer number of the UE, in which bits of the least-significant bit (LSB) part are used to enumerate the layer number of each user equipment (UE), and the remaining most-significant bits (MSBs) are used to enumerate the user equipment (UE), which is abbreviated as a user index. The O-RU uses this division to determine which layers belong to which UEs. The information is important since some DMRS-BF signal processing algorithms may take advantage of the fact that some UE layers belong to the same physical UE, and some radio resource management (RRM) measurements are performed based on each UE and thus represent a combination of the measurement results by the UE layer. The O-RU and O-DU establish connection through UEID, so that after receiving the result report from the O-RU, the O-DU can know which configuration it corresponds to.

In addition to the beamforming methods introduced previously, SRS-based beamforming (SRS-BF) can also be used in the O-RAN. In the fronthaul split option, SRS channel estimation and/or further SRS processing functions are in the O-RU. According to the control plane scheduling message from the O-DU, the O-RU receives the SRS data of the air interface, and then performs channel estimation at the O-RU, without transmitting the SRS data to the O-DU. This can further effectively reduce the bandwidth of the fronthaul interface and save beamforming latency. In the environment of SRS, UEID should include the antenna index information corresponding to the user equipment (UE). When the O-RU supports SRS-BF and DMRS-BF at the same time, the O-RU can refer to the channel estimation results of SRS when performing DMRS-BF, thereby improving the performance of DMRS-BF. Multiple antenna indices of the user equipment (UE) in SRS-BF can be mapped simultaneously to the same layer of the user equipment (UE) in DMRS-BF.

If the SRS-BF processing is set in the O-RU, another advantage is that SRS-BF can be used to perform dimensionality reduction processing for DMRS-BF. Currently, when the O-RU processes uplink data received from PUSCH, the data received by all antennas will be processed by DMRS-BF. Current 5G base stations can have up to 64 or even more antennas, while DMRS-BF needs to process the data received from all antennas. The complexity and resource consumption of this processing cannot be ignored. If SRS-BF is set in the O-RU, the SRS-BF can monitor the channel condition of each antenna. If the channel condition is below a certain threshold, it may be considered that there is a problem with the quality of this antenna. In subsequent calculations, this antenna can be excluded from the calculations, thereby reducing the number of data streams that need to be processed and reducing computational complexity. This is the dimensionality reduction processing of DMRS-BF.

In the O-RAN, both DMRS-BF and SRS-BF use the mapping of UEID. However, due to the different valid durations of UEID in DMRS-BF and SRS-BF, there will be the problem that the SRS-BF configuration cannot be found due to different user indices. There is also the problem that the UEID is the same but the corresponding users are different, resulting in a decrease in beamforming performance or transmission failure.

For DMRS-BF, the mapping of UEID values to the UE layer and eAxC ID values should maintain consistent in one slot. However, the UEID of a UE in different scheduled slots may be different. In SRS-BF, the duration of the UEID of a UE will be long, that is, in N consecutive slots, the UEID corresponding to SRS-BF maintains unchanged.

For example, when an O-RU supports DMRS-BF and SRS-BF at the same time, a UE is arranged in several consecutive slots. The UEID of SRS should be the same in all slots. However, if the management plane function UEID-PERSISTENCE is not enabled (this function forces the DU to assign the same UEID to maintain), the UEID of DMRS-BF may change. Even if this function is enabled, due to the change of the number of layers scheduled by the UE in different slots, the UEID of it will also change. This will be illustrated below through the following examples.

It is assumed that there are 4 slots, 3 least-significant bits of the UEID represent the layer index of DMRS-BF or the port index of SRS-BF, and the remaining 12 most-significant bits are used to represent the user index. It is assumed here that the UE has two ports, and the contents transmitted in the slots are described separately below.

Slot 3: the O-DU transmits the SRS configuration of the UE, the UEID is 000001111101 000 and 000001111101 001, corresponding to the SRS configuration and information, such as corresponding channel estimation of 2 antenna ports respectively. This UEID is still valid in the next 3 slots.

Slot 2: the O-DU transmits the DMRS configuration of the UE, and at this time, only 1 layer is scheduled, and the assigned UEID is 000001111101 000.

Slot 1: the O-DU transmits the DMRS configuration of the UE. At this time, 8 layers are scheduled, and the assigned UEID is 000011111010 000, 000011111010 001, . . . 000011111010 111. Slot 1 can be assigned the same user index as slot 2, or it can be assigned a different user index.

In slot 2 and slot 1, when the O-RU is to use SRS, for slot 2, since the user indices of SRS and DMRS are the same, the O-RU can find the corresponding SRS configuration based on the same user index. However, for slot 1, the user indices of SRS and DMRS are different. In slot 1, the O-RU can only know the configuration corresponding to DMRS and cannot find the matching SRS configuration.

When DMRS-BF is to use SRS-BF, the O-RU should know the association between DMRS-BF and SRS-BF, that is, the O-RU should be able to identify that the DMRS configuration and SRS configuration are for the same UE, and the O-RU can use the results of SRS for DMRS only when performing DMRS-BF, that is, DMRS-BF can refer to the channel estimation results of SRS, thereby improving the performance of DMRS-BF. However, the current O-RAN cannot support it. In the current O-RAN mechanism, the O-DU configures DMRS and SRS respectively through different messages, and may perform the configuring in different slots. The O-RU cannot identify whether DMRS and SRS are for the same UE, and SRS of unrelated UEs may be used for DMRS-BF, causing SRS channel estimation errors.

Therefore, a more flexible, dynamic, and scalable solution is required to indicate the association between SRS and DMRS information. To this end, the disclosure proposes two methods for supporting.

The first method defines a new extension structure so that the O-RU can obtain the user index information of SRS-BF. This method needs to report by the management plane that the O-RU supports the extension structure to the O-DU, and the number of most-significant bits of the supported user index in UEID through the management plane. It should be noted that DMRS-BF and SRS-BF can have different number of bits of user indices. In this new extension structure, the user index information of SRS-BF can be indicated by including UEID in the extension structure. The extension structure can include one or more UEIDs. Specifically, there are the following implementations:
1) this extension structure includes a set of UEIDs and can also include NumAntennaPorts. Due to the different antenna ports, the O-DU can assign multiple SRS-BF related UEIDs to a UE. For example, the least three bits of the UEID represent the port index, and the remaining 12 most-significant bits are used to represent the user index. For each layer of the UE, there will be a corresponding NumAntennaPorts and a corresponding set of UEIDs in the extension structure. The value of each NumAntennaPorts is equal to the number of all available antenna ports allocated for this layer. UEID includes two parts, that is, the user index of the SRS configuration of the UE, and indices of all available antenna port assigned to each layer of the UE. If it is assumed that the UE has two ports, the O-DU can assign two UEIDs to the same UE. The user index information is the same, the port indices are different, and mapped to the same layer of DMRS. In extension structure 1), the extension structure includes UEIDs of two SRS-BFs.
2) this extension structure includes a user index. As in the above example, the least three bits of the UEID represent the port index, and the remaining 12 most-significant bits are used to represent the user index. If it is assumed that the UE has two ports, the O-DU can assign two UEIDs to the same UE. The user index information is the same and the port indices are different. In extension structure 2), the extension structure includes user index information.
3) this extension structure includes a UEID, and the most-significant bit on the left of the UEID is fixed as the user index, but the least-significant bit on the right can convey different information. In extension structure 3), the least-significant bit of the UEID is an index of any antenna port;
4) this extension structure includes a UEID, and the most-significant bit on the left of the UEID is fixed as the user index, but the least-significant bit on the right can convey different information. In extension structure 4), the least-significant bit of the UEID is a largest index of the antenna ports;
5) this extension structure may also include the number of antenna ports that have been allocated for the UE.

Extension structure 2) to extension structure 5) can be used in combination.

The second method for solving the bundling problem is controlled by the O-RU, and implements the mapping by forcing the same user to use the same user index of DMRS-BF and SRS-BF. When the O-RU supports DMRS-BF and SRS-BF at the same time, the O-RU indicates the number of most-significant bits through the management plane to obtain the number of bits occupied by the user index in the UEID, and the remaining least-significant bits represent the antenna port indices or layer indices of the UE. It is required here that the user indices of DMRS-BF and SRS-BF have the same number of bits. When the O-DU performs the SRS configuration in the slot, if there is a new UE, it is assigned a unique user index, and if an existing UE is reconfigured, an existing user index is reused. When the O-DU performs the DMRS configuration in the slot, if the UE already has the SRS configuration, the user index of its corresponding SRS is used, and if the UE does not have the SRS configuration, a new user index is assigned to the UE.

According to the definition and usage method of the user index, the embodiments of the disclosure can be divided into two classes: one class defining a new extension structure, which is marked as class A; one class forcing the same user to use the same user index of DMRS and SRS, which is marked as class B. Embodiment C mainly addresses the issues of out-of-synchronization of reference channel information and latest channel information. Therefore, the disclosure describes 3 embodiments as examples for illustration, in which:

Embodiment A: transmitting the UEID of SRS-BF by defining a new extension structure

Embodiment B: implementing the mapping by forcing the same user to use the same user index of DMRS and SRS

Embodiment C: solving the problem of out-of-synchronization of reference channel information and latest channel information by analyzing different scenarios

Any case that uses the related innovations of the disclosure or combines the innovations of the disclosure falls within the protection scope of the disclosure, which is not limited to the above three embodiments.

Embodiment A: transmitting the UEID by defining a new extension structure

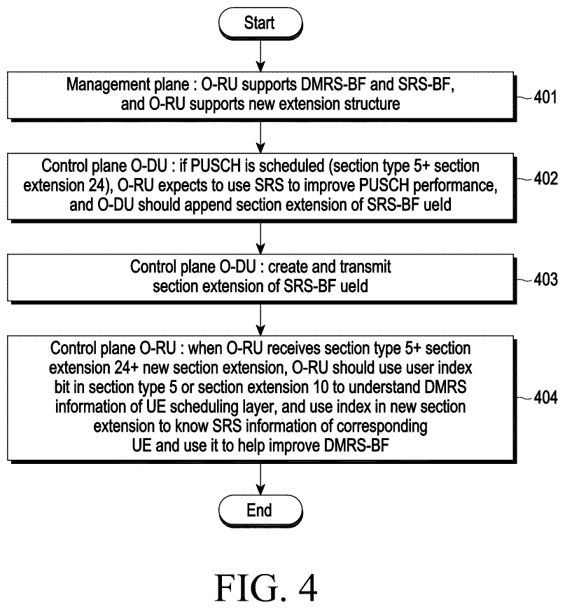

FIGS. 4, 5, 6, and 7 illustrate flowcharts of methods performed by a first network node according to various embodiments of the disclosure.

Referring to FIG. 4, in connection with FIG. 4, the definition and transmission process of the extension structure for transmitting the SRS-BF UEID is described. Referring to FIG. 4, the method includes:

At operation 401, the O-RU reports, to the O-DU, the DMRS-BF and SRS-BF capabilities, the number of most-significant bits of the UEID occupied by the user index, and the support of the extension structure for transmitting the SRS-BF UEID.

This process is performed in the management planes of the O-RU and the O-DU. A section extension related to an SRS-BF UEID transmission capability is added to the list of section extensions in the management plane to implement the support of SRS-BF UEID mapping.

Optionally, the O-RU reports its supported section extensions to the O-DU through the list of section extensions (supported-section-extensions). If the supported-section-extensions supported by the O-RU include the section extension related to the SRS-BF UEID transmission capability, it can be determined that the O-RU supports the section extension. If the supported-section-extensions supported by the O-RU do not include the section extension related to the SRS-BF UEID transmission capability, it is determined that the O-RU does not support the section extension.

Optionally, the O-RU reports, to the O-DU, the number of most-significant bits in the UEID for SRS-BF occupied by the user index.

If the O-DU supports the transmission of the SRS-BF UEID, when the O-DU receives the list of section extensions reported by the O-RU, if the list of section extensions reported by the O-RU carries the section extension related to the SRS-BF UEID transmission capability, the O-RU also supports the transmission of the SRS-BF UEID section extension. Otherwise, the transmission of the SRS-BF UEID section extension is not enabled. If the O-DU does not support the SRS-BF UEID section extension, for backward compatibility, the O-DU ignores the transmission capability of the O-RU with respect to the SRS-BF UEID.

Operation 402, a triggering process of SRS-BF UEID transmission.

This process is performed in the O-DU, which determines when the SRS-BF UEID transmission is required. Specifically, if PUSCH is scheduled, the O-DU needs to transmit section type 5 and section extension 24 to support DMRS-BF. At the same time, the O-RU expects to use SRS-BF to improve the performance of PUSCH. At this time, the O-DU should add the SRS-BF UEID section extension for transmission.

Operation 403, a process of creating and transmitting the SRS-BF UEID section extension. This process is performed in the O-DU, and the creation and transmitting process of the control plane message is the same as the creation and transmitting process of the existing related control plane messages. The newly added section extension structures can be defined as shown in Table 1 below. A number of UEIDs included in the structure shown in Table 1 is the same as a total number of layers of all scheduled users, and the content of the UEID that represents the antenna port value part can represent a maximum number of ports allocated to each layer of the user.

TABLE 1

| | | | | | | | | # of | |
|---|---|---|---|---|---|---|---|---|---|
| 0 (msb) | 1 | 2 | 3 | 4 | 5 | 6 | 7 (lsb) | bytes | |
| ef | extType | | | | | | | 1 | Octet N |
| exLen = var | | | | | | | | 1 | N + 1 |
| Reserved | 1^{st}UEID [14: 8] | | | | | | | 1 | N + 2 |
| 1^{st}UEID [7: 0] | | | | | | | | 1 | N + 3 |
| Reserved | 2^{nd}UEID [14: 8] | | | | | | | 1 | N + 4 |
| 2^{nd}UEID [7: 0] | | | | | | | | 1 | N + 5 |
| Reserved | . . . | | | | | | | | |
| . . . | | | | | | | | | |
| Reserved | last UEID [14: 8] | | | | | | | | var |
| last UEID [7: 0] | | | | | | | | | var |
| zero padding to ensure 4-byte boundary | | | | | | | | | var |

The description of each extension field in the extension structure shown in Table 1 above is as follows:
ef (extension flag): 1 bit, an extension identifier. When ef=1, it indicates that there are other section extensions after this section extension; when ef=0, it indicates that this extension is the last section extension. It should be understood that if this section extension exists, ef in its previous section description or section extension should be identified as 1.
extType (extension type): 7 bits, indicating an extension type. For this extension type, a section extension number can be filled. For example, the number starts from 0. If there are already other section extensions before this section extension (such as extension type 0, extension type 1 and extension type 2), an extension type number of this section extension is 3.
extLen (extension length): 8 bits, a size of the extension structure, indicating how many 32 bits or how many 4 bytes the entire extension occupies.

UEID: 15 bits, a user equipment identifier. When used in the environment of SRS-BF, the UEID can be divided into two parts, that is, a user index and an antenna port number. The bits occupied by the antenna port number are selected by starting from the least-significant bit, with a size determined by the number of antenna ports, and the number of antenna ports is controlled by the management plane parameter UEID-max-port-bits reported by the O-RU. An example of parameter division of UEID is shown in Table 2.

TABLE 2

| | | | | | | | | | | | | | | Antenna | |
|---|---|---|---|---|---|---|---|---|---|---|---|---|---|---|---|
| | User Index | | | | | | | | | | | | | Port Number | |
| UEID | 14 | 13 | 12 | 11 | 10 | 9 | 8 | 7 | 6 | 5 | 4 | 3 | 2 | 1 | 0 |

The total number of UEIDs in the section extension can be equal to the total number of UEs scheduled in the message, or it can be equal to the sum of the number of antenna ports of each UE (this case assumes that allocating of indices by the O-DU is random and irregular). When the number of UEIDs is equal to the total number of UEs scheduled in the message, each UE has only one UEID, and the most-significant bit of the UEID is fixedly represented as the user index, but the least-significant bit can convey different information: 1) an index of any antenna port; 2) an index largest of the antenna port assigned to the UE; 3) a number of antenna indices that have been assigned to the UE.

Table 3 is another implementation. In the structure shown in Table 3, the total number of UEIDs included in the section extension is equal to the sum of the number of antenna ports of all UEs scheduled in the message.

TABLE 3

| | | | | | | | | | # of | |
|---|---|---|---|---|---|---|---|---|---|---|
| 0 (msb) | 1 | 2 | 3 | 4 | | 5 | 6 | 7 (lsb) | bytes | |
| Ef | extType | | | | | | | | 1 | Octet N |
| exLen = var | | | | | | | | | 1 | N + 1 |
| 1^{st}layer NumAntennaPorts | | | | | Reserved | | | | | N + 2 |
| Reserved | 1^{st}ueId [14: 8] | | | | | | | | 1 | N + 3 |
| 1^{st}ueId [7: 0] | | | | | | | | | 1 | N + 4 |
| Reserved | . . . | | | | | | | | | var |
| . . . | | | | | | | | | | var |
| Reserved | last ueId [14: 8] | | | | | | | | 1 | var |
| last ueId [7: 0] | | | | | | | | | 1 | var |
| . . . | | | | | | | | | . . . | var |
| . . . | | | | | | | | | | var |
| last layer NumAntennaPorts | | | | | Reserved | | | | 1 | var |
| Reserved | 1^{st}ueId [14: 8] | | | | | | | | 1 | var |
| 1^{st}ueId [7: 0] | | | | | | | | | 1 | var |
| Reserved | . . . | | | | | | | | | var |
| . . . | | | | | | | | | | var |
| Reserved | last ueId [14: 8] | | | | | | | | 1 | var |
| last ueId [7: 0] | | | | | | | | | 1 | var |
| zero padding to ensure 4-byte boundary | | | | | | | | | var | var |

The description of each extension field in the extension structure shown in Table 3 above is as follows:

number of antenna ports (NumAntennaPorts): 4 bits, indicating the number of antenna ports for SRS-BF corresponding to each layer of DMRS-BF users. The number of parameter NumAntennaPorts in this section extension is equal to the number of layers of all scheduled users. NumAntennaPorts of the first layer indicates the number of ports for SRS-BF corresponding to the first layer of the first scheduled user, and the number of UEIDs following it is consistent with the value of the first NumAntennaPorts; the second NumAntennaPorts indicates the number of ports for SRS-BF corresponding to the next layer of the user or the first layer of the next user, and the number of UEIDs following it is consistent with the value of the NumAntennaPorts, and so on until all layers of all users are enumerated. The structure includes all UEIDs related to the SRS configuration.

The interpretation of other fields in Table 3 refers to the interpretation of the same fields in Table 1.

The above description is only an implementation. According to the first method of the disclosure, there are other implementations. For the five extension structures mentioned in the first method, only corresponding adaptive modifications are required. Its core idea is to convey the user index information and/or the indices of the ports for SRS-BF of each UE so that it can be used subsequently. The above method is to reuse the UEID defined in the existing standard, but in fact, new parameters, such as srsPortID can also be defined, and the fields of the parameters are not necessarily limited to 15 bits.
zero padding to ensure 4-byte boundary: padding 0 bits, for maintaining the number of bytes occupied by the section extension consistent with the number of bytes defined by extLen.

Operation 404, a reception and parsing process of the control plane message corresponding to the SRS-BF UEID transmission, which is performed in the O-RU.

The O-RU parses the received message, and for the control plane message, identifies whether a section extension for the SRS-BS UEID transmission is included according to the extension field extType. When the O-RU receives section type 5, section extension 24, and the extension for the SRS-BS UEID transmission, the O-RU should use the user index bits in section type 5 or section extension 10 to understand the DMRS information of the UE scheduling layer, and use the user index in the section extension for the SRS-BS UEID transmission to understand the port index information of the SRS of the corresponding UE, and use it to help improve DMRS-BF, such as using SRS for dimensionality reduction.

Embodiment B: implementing the mapping by forcing the same user to use the same user index of DMRS and SRS

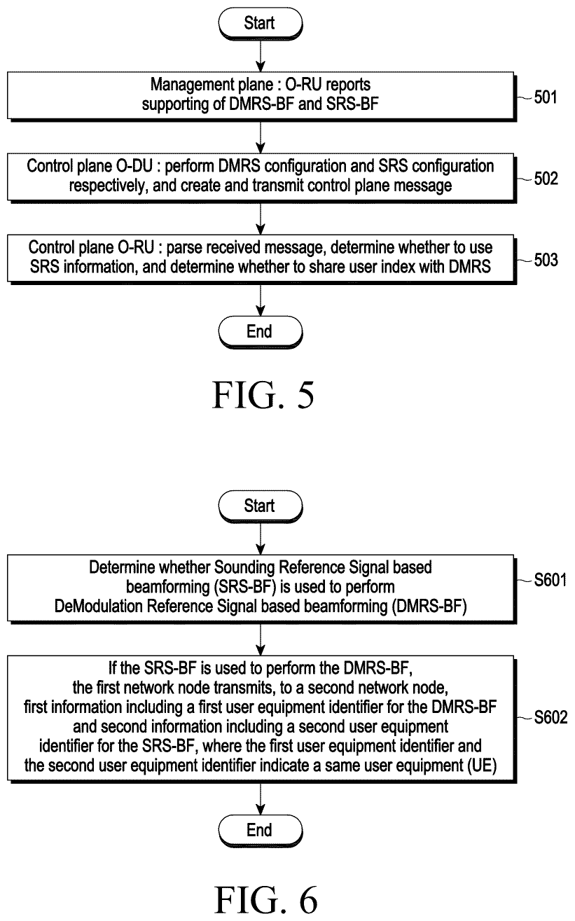

Referring to FIG. 5, the method for sharing user indices between DMRS-BF and SRS-BF will be described below. As shown in FIG. 5, the method includes:

At operation 501, the O-RU reports capabilities to the O-DU. Through a management plane message, the O-RU reports whether DMRS-BF and SRS-BF are supported, and reports the number of most-significant bits of UEID occupied by the user index. For a specific implementation, see operation 401.

Operation 502, a process of the DMRS and SRS configuration and transmitting the control plane message

This process is performed in the O-DU. The O-DU first determines whether the O-RU uses SRS in DMRS-BF, which can be determined by the following three methods:
1) the O-RU reports whether to enable the capability of using SRS through the management plane. If the capability is enabled, and at the same time, the O-DU performs the configuration, the O-RU uses SRS information when detecting the SRS information during DMRS-BF; if the capability is not enabled, SRS is not used for enhancement. This method is suitable for the case that the configuration is not changed for a long time.
2) the management plane configures the O-DU to enable/activate the function of enhancing DMRS-BF with the SRS capability, and meanwhile, the management plane, or the O-DU through the management plane message, informs the O-RU to enable/activate the function of enhancing DMRS-BF with the SRS capability. When the management plane configures the O-DU to disable/deactivate the function of enhancing DMRS-BF with the SRS capability, the management plane, or the O-DU through the management plane message, informs the O-RU to disable/deactivate the function of enhancing DMRS-BF with the SRS capability.
3) the field reserved in a PUSCH DMRS configuration of section extension 24 is changed to srsEnInd. When srsEnInd is 1, it means that SRS is to be used, and when srsEnInd is 0, SRS is not used. This method is suitable for finer-grained configuration, and the configuration can be changed in different slots. The structure of the changed section extension 24 can be as shown in Table 4.

TABLE 4

| | | | | | | | | # of | |
|---|---|---|---|---|---|---|---|---|---|
| 0 (msb) | 1 | 2 | 3 | 4 | 5 | 6 | 7 (lsb) | bytes | |
| ef | extType = 0x18 | | | | | | | 1 | Octet N |
| exLen = var | | | | | | | | 1 | N + 1 |
| alpnPersSym | antDmrsSnr | | srsEnInd | | userGroupSize [4: 0] | | | 1 | N + 2 |

A part of the fields in the extension structure shown in Table 4 are the same as the fields in the extension structure shown in Table 1 in the above embodiment A. For the sake of simplicity of description, the same fields are not repeated here, and only fields newly added in the standard are described:

SRS enabled indication (srsEnInd): 1 bit, indicating whether DMRS-BF is to be used in combination with SRS-BF for functional enhancement. When srsEnInd=1, it indicates that DMRS-BF is to be used in combination with SRS-BF for functional enhancement; when srsEnInd=0, it indicates that DMRS-BF does not need to be used in combination with SRS-BF.

Operation 503, a process of the user index configuration

When the O-RU supports DMRS-BF and SRS-BF at the same time, the O-RU indicates the number of most-significant bits of UEID for representing the user index through the management plane, and the remaining least-significant bits represent the antenna port index of the UE. When the O-RU receives section type 5 and section extension 24, the O-RU should check the value of srsEnInd. If srsEnInd is equal to 1, it indicates that SRS-BF will be used for DMRS-BF, and SRS-BF and DMRS-BF will use the same UE index.

When the O-DU performs the SRS-BF configuration in the slot, if there is a new UE, it is assigned a unique user index, and if an existing UE is reconfigured, the existing user index is reused.

When the O-DU performs the DMRS-BF configuration in a certain slot, if the function of enhancing DMRS-BF with the SRS capability is enabled or activated, and the UE already has the SRS-BF configuration, that is, it has been assigned SRS-BF related UEID, the O-DU configures the user index in the DMRS-BF related UEID to be equal to the user index of SRS-BF, that is, the user index in the DMRS-BF related UEID is the same as the user index in the SRS-BF related UEID. With the same user index, the O-RU can use the results of SRS-BF for DMRS-BF. When performing DMRS-BF, the O-RU can refer to the channel estimation results of SRS-BF, thereby improving the performance of DMRS-BF; if SRS-BF has not been configured, the O-DU assigns a new user index to the UE, which can be used as the UEID of SRS-BF and/or the UEID of DMRS-BF.

FIG. 6 illustrates a flowchart of a method performed by a first network node according to an embodiment of the disclosure.

Referring to FIG. 6, at operation S601, the first network node determines whether sounding reference signal based beamforming (SRS-BF) is used to perform demodulation reference signal based beamforming (DMRS-BF).

At operation S602, if the SRS-BF is used to perform the DMRS-BF, the first network node transmits, to a second network node, first information including a first user equipment identifier for the DMRS-BF and second information including a second user equipment identifier for the SRS-BF, where the first user equipment identifier and the second user equipment identifier indicate a same user equipment (UE).

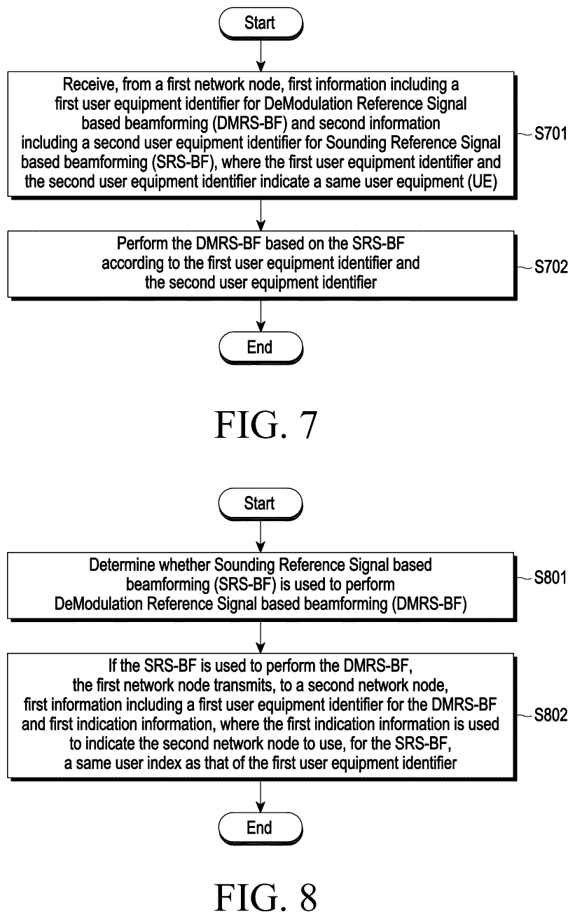

FIG. 7 illustrates a flowchart of a method performed by a second network node according to an embodiment of the disclosure.

Referring to FIG. 7, at operation S701, the second network node receives, from a first network node, first information including a first user equipment identifier for demodulation reference signal based beamforming (DMRS-BF) and second information including a second user equipment identifier for sounding reference signal based beamforming (SRS-BF), where the first user equipment identifier and the second user equipment identifier indicate a same user equipment (UE).

At operation S702, the second network node performs the DMRS-BF based on the SRS-BF according to the first user equipment identifier and the second user equipment identifier.

FIG. 8 illustrates a flowchart of a method performed by a first network node according to an embodiment of the disclosure.

Referring to FIG. 8, at operation S801, the first network node determines whether sounding reference signal based beamforming (SRS-BF) is used to perform demodulation reference signal based beamforming (DMRS-BF).

At operation S802, if the SRS-BF is used to perform the DMRS-BF, the first network node transmits, to a second network node, first information including a first user equipment identifier for the DMRS-BF and first indication information, where the first indication information is used to indicate the second network node to use, for the SRS-BF, a same user index as that of the first user equipment identifier.

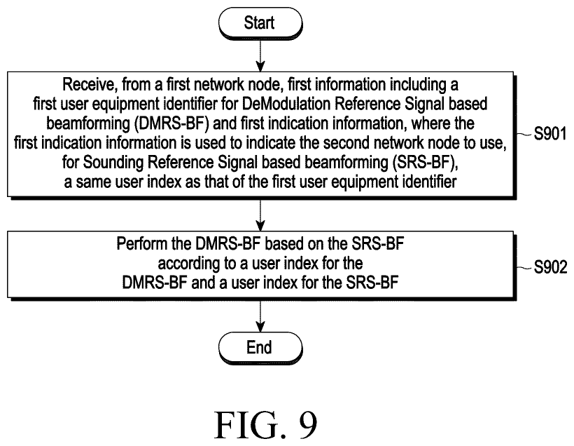

FIG. 9 illustrates a flowchart of a method performed by a second network node according to an embodiment of the disclosure.

Referring to FIG. 9, at operation S901, the second network node receives, from a first network node, first information including a first user equipment identifier for demodulation reference signal based beamforming (DMRS-BF) and first indication information, where the first indication information is used to indicate the second network node to use, for sounding reference signal based beamforming (SRS-BF), a same user index as that of the first user equipment identifier.

At operation S902, the second network node performs the DMRS-BF based on the SRS-BF according to a user index for the DMRS-BF and a user index for the SRS-BF.

Embodiment C: solving the problem of out-of-synchronization of reference channel information and latest channel information by analyzing different scenarios

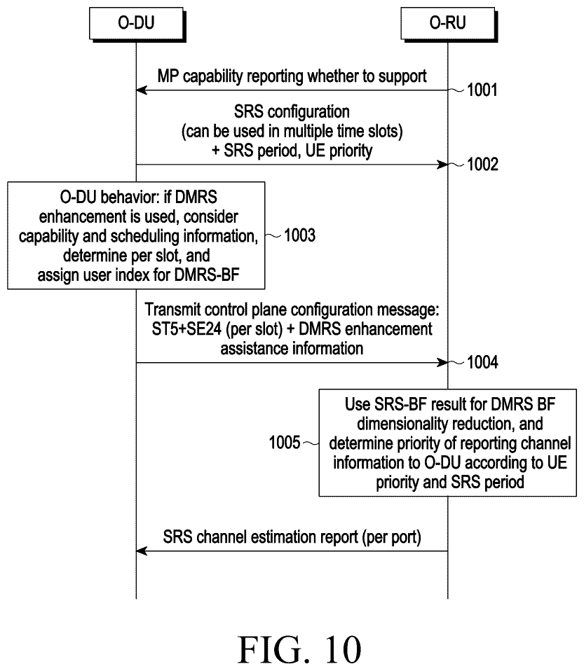

FIG. 10 depicts an embodiment in which the problem of out-of-synchronization of channel information is solved according to an embodiment of the disclosure.

Referring to FIG. 10, when the SRS-BF results are used for DMRS-BF, there will also be a problem of out-of-synchronization of O-DU and O-RU channel information. Specifically, the O-DU schedules PUSCH resources based on the channel information (CI) (which is referred to as reference CI) received from the O-RU. When channel estimation is performed in the O-DU, the O-DU refers to the channel information to perform PUSCH scheduling and transmits the channel information, PUSCH configuration and DMRS configuration to the O-RU. The O-RU uses these configuration and channel information to process PUSCH data. In this way, the channel information between the O-DU and the O-RU is synchronized. When SRS-BF is in the O-RU, the O-RU performs channel estimation calculation and then reports the channel information (CI) to the O-DU. The O-DU refers to the received CI to perform PUSCH resource scheduling. The O-DU transmits DMRS-BF and PUSCH configuration messages to the O-RU. When the O-RU receives PUSCH data from the UE, the O-RU obtains the latest channel information (CI) by SRS-BF, and then uses the latest CI to perform dimensionality reduction on DMRS-BF. However, a problem arises: if the difference between the reference CI and the latest CI is large, it is better not to use the latest CI to generate DMRS-BF weights, that is, not to apply the results of SRS-BF to DMRS-BF. Otherwise, the performance of DMRS-BF may be decreased. This is the problem of out-of-synchronization between the O-DU and the O-RU. This can occur if the channel state changes rapidly and the SRS period is short. If the difference between the reference CI and the latest CI is large, the problem of out-of-synchronization in the O-RU and the O-DU may decrease system performance. How to solve the synchronization between the reference CI in the O-DU and the latest CI in the O-RU is another problem. FIG. 10 depicts an embodiment in which the problem of out-of-synchronization of the channel information is solved. Through this embodiment, when the reference CI used by the O-DU when performing PUSCH scheduling is inconsistent with the latest CI used by the O-RU in latest data processing, problems, such as channel quality, system capacity, and user experience degradation due to the inconsistency can be reduced.

The following is a more detailed description. For the configuration of PUSCH and DMRS, the O-DU needs to perform the following three steps, which span multiple slots. In TS0, the O-DU determines the scheduling configuration of PUSCH based on the available channel information. In TS1, the O-DU prepares a CP message, e.g., ST5+SE24. In TS2, the O-DU transmits the CP message to the O-RU. However, when the O-RU supports SRS-BF, the O-RU calculates the latest CI. The O-RU should process PUSCH according to the latest channel information. When the O-DU configures PUSCH and DMRS-BF, it performs the configuration based on old CI. For example, the UE antenna ports should be 1 and 2. Based on the latest channel information, the best UE antenna ports are 3 and 4. If the latest channel information is used for dimensionality reduction, the decoding error may increase.

At operation 1001: the O-RU reports to the O-DU whether the O-RU supports SRS-BF. This function can be reported through new parameters defined in the management plane.

At operation 1002: the O-DU transmits SRS-related configuration information to the O-RU.

The O-DU transmits SRS configuration to the O-RU in each SRS scheduling period (e.g., 8 slots) through section type yy (ST yy). ST yy is a new section type for transmitting SRS configuration to the O-RU. The O-RU may calculate the channel quality based on the received SRS configuration. This calculation is performed in each SRS scheduling period. Through the SRS-BF calculation, the quality of each antenna can be obtained. This result can be used for DMRS-BF dimensionality reduction. The O-RU may report channel information to the O-DU. The O-DU transmits the DMRS configuration to the O-RU through ST5 and SE24, and this configuration may be transmitted by slot. The O-RU processes PUSCH data through DMRS-BF and considers the results of SRS-BF, for example, only processes data received from antenna ports with good quality and discards data received from other antenna ports.

In this message, the O-DU can also provide SRS-related information, e.g., information, such as SRS period, user priority, to the O-RU. This may help the O-RU report channel information in advance to prevent the problem of out-of-synchronization.

At operation 1003: the O-DU determines PUSCH scheduling and DMRS configuration of each slot. The O-DU further determines whether SRS-BF can be used to perform dimensionality reduction on DMRS.

For the O-DU information, there are the following four cases. In each case, the O-DU behaves differently.

Case 1: the O-DU can determine that the channel information CI in the O-RU and the O-DU is basically consistent, based on the received CI. No special processing is required in the O-DU. The O-DU determines whether SRS can be used to enhance DMRS-BF, and if so, it transmits a new section extension including bundling information appended to DMRS configuration.

Case 2: reference channel information CI-1 is used to transmit scheduling information in slot N-2. New channel information CI-2 is obtained in slot N. Since the new reference channel information CI-2 is obtained in a control plane message transmission stage, if the difference between CI-2 and CI-1 is large, it will be too late to transmit PUSCH scheduling and DMRS configuration in slot N to the O-RU in case that rescheduling is performed due to the scheduling for slot N, so the O-DU cannot perform the rescheduling. The O-DU determines whether SRS (based on old channel information CI) needs to be used for DMRS. The determination may be based on SRS period, sub-band, or full-band. For example, if a shorter SRS period is used, it means that the channel environment changes quickly, so the determined DMRS-BF channel information may not be reasonable. In this case, the O-DU may determine not to use SRS channel information CI to enhance DMRS-BF to avoid performance degradation, i.e., not to connect new section extensions.

Case 3: reference channel information CI-1 is used to transmit scheduling information in slot N-2. A new CI-2 is obtained in slot N-1. Since the new reference CI-2 is obtained in a control plane message preparation phase, partial rescheduling can be performed. For certain users, the latest CI-2 is received early, which enables the O-DU to generate control plane scheduling information in time. For certain users, the latest CI-2 is received late, and the O-DU does not have time to generate new control plane scheduling information based on the new channel information CI-2.

Case 4: reference channel information CI-1 is used to transmit scheduling information in slot N-2. New channel information CI-2 is obtained in slot N-2. Since the new reference channel information CI-2 is obtained in a control plane scheduling information generation phase, rescheduling can be performed.

At operation 1004: the O-DU transmits a control plane configuration message to the O-RU.

If PUSCH is scheduled, the O-DU transmits the control plane configuration message (ST5+SE24) for DMRS-BF configuration. ST5 includes UE scheduling information, including PRB resources and UEID. SE24 is used with ST5 to deliver a PUSCH DMRS configuration for each UE (indicated by UEID in ST5). The O-RU processes the PUSCH data received from the UE according to the DMRS configuration in the slot and reports the RRM measurement results to the O-DU through section type 10. Section type 10 includes UEID of the UE and the RRM measurement report.

In addition, the control plane configuration message may further carry indication information that SRS-BF is used for DMRS-BF. This indication information may be through one of the following two methods:

O-DU control method: a new section extension is created, which is used to indicate whether DMRS-BF enhancement is enabled. The section extension includes an assigned user index and antenna port list, which will be used for DMRS-BF enhancement; this new section extension has been set forth in the above embodiments and is omitted here.

O-RU control method: the O-DU forces SRS-BF and DMRS-BF to use the same user index, and uses a flag to indicate the O-RU to use SRS-BF for DRMS-BF. The selected port for DMRS-BF is determined by the O-RU. If PUSCH has been scheduled and SRS-BF cannot be used for DMRS enhancement, the O-DU should transmit an ST5+SE24 message without flag information. This flag information has been set forth in the above embodiments and is omitted here.

At operation 1005: the O-RU receives the control plane configuration message, parses the bundling information to obtain SRS information of the UE, and uses it for DMRS-BF dimensionality reduction. The O-RU determines a priority of channel information reporting based on the UE priority and SRS period, and determines whether there may be a problem of out-of-synchronization between the reference CI and the latest CI. If there is the problem, the O-RU will report the latest CI of the UE in advance according to the UE priority.

The O-RU determines a priority of channel information CI reporting based on the user priority and SRS period. As an enhancement function, if the O-RU receives information related to the SRS period, user priority, or the like, the O-RU can report user channel information with the highest level to the O-DU as early as possible, which will facilitate the scheduling by the O-DU. If the O-RU knows the SRS period and user priority, it can determine whether to check the validity of DMRS enhancement, and determine whether to use DMRS enhancement based on whether the performance of enhanced DMRS is better than the performance of unenhanced DMRS.

At operation 1006, the O-RU transmits an SRS channel estimation report to the O-DU.

The SRS channel estimation report includes latest channel estimation results.

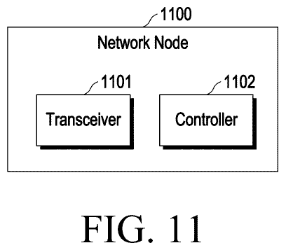

FIG. 11 illustrates a block diagram of a network node 1100 according to an embodiment of the disclosure. The network node 1100 may comprise an O-DU or O-RU.

Referring to FIG. 11, the network node 1100 according to various embodiments of the disclosure may include a transceiver 1101 and a controller 1102. For example, the transceiver 1101 may be configured to transmit and receive signals. For example, the controller 1102 may be coupled to the transceiver 1101 and configured to perform the aforementioned methods. The controller may be implemented through at least one processor. The network node may comprise memory storing instructions. The instructions, when executed by the at least one processor individually or collectively, may cause the network node 1100 to perform the aforementioned methods.

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the disclosure as generally described herein and shown in the drawings may be arranged, replaced, combined, separated and designed in various different configurations, all of which are contemplated herein.

Those skilled in the art will understand that the various illustrative logical blocks, modules, circuits, and steps described in the application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of the application.

The various illustrative logic blocks, modules, and circuits described in the application may be implemented or performed by a general purpose processor, a digital signal processor (DSP), an application specific integrated circuit (ASIC), a field programmable gate array (FPGA) or other programmable logic devices, discrete gates or transistor logics, discrete hardware components, or any combination thereof designed to perform the functions described herein. The general purpose processor may be a microprocessor, but in an alternative, the processor may be any processor of the related art, controller, microcontroller, or state machine. The processor may also be implemented as a combination of computing devices, such as a combination of a DSP and a microprocessor, more than one microprocessors, one or more microprocessors cooperating with a DSP core, or any other such configuration.

The operations of the method or algorithm described in the application may be embodied directly in hardware, in a software module executed by a processor, or in a combination thereof. The software module may reside in random access memory (RAM) memory, flash memory, read only memory (ROM) memory, erasable programmable read only memory (EPROM) memory, electrically erasable programmable read only memory (EEPROM) memory, register, hard disk, removable disk, or any other form of storage medium known in the art. A storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a first network node in a wireless communication system, the method comprising:
receiving, from a second network node, first information related to the second network node supporting sounding reference signal based beamforming (SRS-BF); and
transmitting, to the second network node, a configuration message for demodulation reference signal based beamforming (DMRS-BF),
wherein the configuration message comprises first user equipment (UE)-related configuration information corresponding to the DMRS-BF and second UE-related configuration information corresponding to the SRS-BF.

2. The method of claim 1,
wherein the transmitting, to the second network node, the configuration message for the DMRS-BF comprises:
transmitting, to the second network node, the configuration message for the DMRS-BF when the SRS-BF can be applied to the DMRS-BF.

3. The method of claim 1,
wherein the first UE-related configuration information is carried in a first section extension of the configuration message, and
wherein the second UE-related configuration information is carried in a second section extension corresponding to the first section extension in the configuration message.

4. The method of claim 3,
wherein the first section extension comprises at least one first extension field, the second section extension comprises at least one second extension field, and
wherein a first extension field of the at least one first extension field that comprises the first UE-related configuration information corresponds to a second extension field of the at least one second extension field that comprises the second UE-related configuration information.

5. The method of claim 3, wherein the first information comprises:
identification information of the second section extension.

6. The method of claim 3, wherein the second section extension comprises at least one of:
UE index related information; or
antenna port related information.

7. The method of claim 6, wherein the antenna port related information comprises at least one of:
at least one antenna port index;
a number of antenna ports; or
an index of an antenna port with a largest index value.

8. The method of claim 1,
wherein the second UE-related configuration information comprises indication information indicating that the DMRS-BF and the SRS-BF correspond to a UE.

9. The method of claim 1,
wherein the receiving, from the second network node, the first information related to the second network node supporting the SRS-BF comprises:
receiving, from the second network node, a management plane message comprising the first information related to the second network node supporting the SRS-BF.

10. The method of claim 1,
wherein the transmitting, to the second network node, the configuration message for the DMRS-BF comprises:
transmitting, to the second network node, a control plane message comprising the configuration message for the DMRS-BF.

11. The method of claim 1, wherein the transmitting, to the second network node, the configuration message for the DMRS-BF comprises:
transmitting, to the second network node, the configuration message for the DMRS-BF when scheduling and processing of a physical uplink shared channel (PUSCH) belong to a same SRS channel information reporting period.

12. The method of claim 1, further comprising:
transmitting, to the second network node, SRS configuration information, wherein the SRS configuration information comprises at least one of an SRS configuration period or UE priority information; and
receiving, from the second network node, channel information, wherein the channel information is determined by the second network node based on the SRS configuration information.

13. A method performed by a second network node in a wireless communication system, the method comprising:
transmitting, to a first network node, first information related to the second network node supporting sounding reference signal based beamforming (SRS-BF); and
receiving, from the first network node, a configuration message for demodulation reference signal based beamforming (DMRS-BF),
wherein the configuration message comprises first user equipment (UE)-related configuration information corresponding to the DMRS-BF and second UE-related configuration information corresponding to the SRS-BF.

14. The method of claim 13,
wherein the receiving, from the first network node, the configuration message for the DMRS-BF comprises:
receiving, from the first network node, the configuration message for the DMRS-BF when the SRS-BF can be applied to the DMRS-BF.

15. The method of claim 13,
wherein the first UE-related configuration information is carried in a first section extension of the configuration message, and
wherein the second UE-related configuration information is carried in a second section extension corresponding to the first section extension in the configuration message.

16. The method of claim 15,
wherein the first section extension comprises at least one first extension field, the second section extension comprises at least one second extension field, and
wherein a first extension field of the at least one first extension field that comprises the first UE-related configuration information corresponds to a second extension field of the at least one second extension field that comprises the second UE-related configuration information.

17. The method of claim 15, wherein the first information comprises:
identification information of the second section extension.

18. The method of claim 15, wherein the second section extension comprises at least one of:
UE index related information; or
antenna port related information.

19. The method of claim 18, wherein the antenna port related information comprises at least one of:
at least one antenna port index;
a number of antenna ports; or
an index of an antenna port with a largest index value.

20. A first network node in a wireless communication system, the first network node comprising:
memory, comprising one or more storage media, storing instructions; and
at least one processor communicatively coupled to the memory and the transceiver,
wherein the instructions, when executed by the at least one processor individually or collectively, cause the first network node to:
receive, from a second network node, first information related to the second network node supporting sounding reference signal based beamforming (SRS-BF), and
transmit, to the second network node, a configuration message for demodulation reference signal based beamforming (DMRS-BF), and
wherein the configuration message comprises first user equipment (UE)-related configuration information corresponding to the DMRS-BF and second UE-related configuration information corresponding to the SRS-BF.
